(19) United States
(12) Patent Application Publication
(10) Pub. No.: US 2014/0347327 A1
(43) Pub. Date: Nov. 27, 2014

(54) TOUCH PEN STRUCTURE

(71) Applicant: Chi-Ming Wu, New Taipei City (TW)

(72) Inventor: Chi-Ming Wu, New Taipei City (TW)

(21) Appl. No.: 13/901,577

(22) Filed: May 24, 2013

(51) Int. Cl. G06F 3/0354

(52) U.S. Cl. CPC G06F 3/03545
USPC 345/179

(57) ABSTRACT

The present invention provides a touch pen structure, especially to a touch pen structure which can be used for replacing fingers to operate a touch screen, which includes: a main body, at least a pen core, an electric conductive touch sleeve and an end cap. The electric conductive touch sleeve and the pen core are installed at the same end, thereby being enabled to be directly used for sliding and pressing on a touch panel and also writing on paper without turning the main body.

### BACKGROUND OF THE INVENTION

1. Field of the Invention

The present invention relates to a pen, especially to a touch pen structure capable of being directly used for sliding and pressing on a touch panel and also writing on paper without turning a main body thereof.

2. Description of Related Art

A conventional touch pen structure used for sliding and pressing on a touch panel is installed with a soft pad at the top of a main body thereof, a structural space formed at the bottom of the main body has to be reserved for accommodating and exposing a pen core, so the soft pad used for operating the touch screen is unable to be installed at the bottom of the main body, the conventional touch pen is limited to a rotary structure, a retractable structure (i.e. the pen core being pressed for exposing) having a press button at the top is unable to be adopted, so the soft pad is installed at the top thereby allowing the pen core to be protruded at the bottom, the touch pen structure is very much restrained, when a use desires to use the touch pen to operate the touch panel, the first step is to turn the main body having the pen core at the bottom, so the soft pad installed at the top of the main body is enabled to be faced downward, when the user desires to use the pen core for writing and recording the data shown in the touch panel, the user has to turn the main body one more time for allowing the pen core of the main body to be faced downward so as to be used for writing on paper, furthermore, for enabling the main body to meet the ergonomic requirement so as to achieve the objectives of easy to hold and stable in use, the top portion and the lower portion of the main body are often designed in different shapes, in a conventional touch pen which is aimed to provide functions of writing on paper and sliding and pressing on the touch panel, the soft pad has to be installed at the top of the main body and is unable to be installed at the bottom of the main body, as such, when the user uses the soft pad installed at the top of the main body, he has to hold at a location of the main body opposite to the location being held for writing, so complying with the ergonomic requirement is not achieved, and problems such as inadequate effort for holding, unstable operating, uncomfortable in use or even damage may occur; when in use, if writing on paper and sliding and pressing the touch panel for displaying data are both required to be operated, the main body has to be repeatedly turned, thereby wasting time and effort in use and causing inconvenience, the operation efficiency and practicability are severely affected. The mentioned disadvantage shall be improved by the skilled people in the art. The applicant of the present invention has devoted himself for inventing a touch pen structure in which an electric conductive touch sleeve used for sliding and pressing on a touch panel being able to be installed below a pen core, so the touch pen can be directly used for sliding and pressing on the touch panel and also writing on paper without turning the main body of the touch pen structure, thereby effectively increasing the smoothness and convenience in use and enhancing the holding strength and stability.

### SUMMARY OF THE INVENTION

For solving the disadvantage of prior art, one primary objective of the present invention is to provide a touch pen structure, in which an electric conductive touch sleeve and a pen core are installed at the same end, thereby being enabled to be directly used for sliding and pressing on a touch panel and also writing on paper without turning the main body of the touch pen.

Another objective of the present invention is to provide a touch pen structure capable of effectively increasing the smoothness and convenience in use.

One another objective of the present invention is to provide a touch pen structure capable of enhancing the holding strength and stability.

The disadvantages aimed to be solved by the present invention is that: a conventional touch pen structure used for sliding and pressing on a touch panel is installed with a soft pad at the top of a main body thereof, a structural space formed at the bottom of the main body has to be reserved for accommodating and exposing a pen core, so the soft pad used for operating the touch screen is unable to be installed at the bottom of the main body, the conventional touch pen is limited to a rotary structure, a retractable structure (i.e. the pen core being pressed for exposing) having a press button at the top is unable to be adopted, so the soft pad is installed at the top thereby allowing the pen core to be protruded at the bottom, the touch pen structure is very much restrained, when a use desires to use the touch pen to operate the touch panel, the first step is to turn the main body having the pen core at the bottom, so the soft pad installed at the top of the main body is enabled to be faced downward, when the user desires to use the pen core for writing and recording the data shown in the touch panel, the user has to turn the main body one more time for allowing the pen core of the main body to be faced downward so as to be used for writing on paper, furthermore, for enabling the main body to meet the ergonomic requirement so as to achieve the objectives of easy to hold and stable in use, the top portion and the lower portion of the main body are often designed in different shapes, in a conventional touch pen which is aimed to provide functions of writing on paper and sliding and pressing on the touch panel, the soft pad has to be installed at the top of the main body and is unable to be installed at the bottom of the main body, as such, when the user uses the soft pad installed at the top of the main body, he has to hold at a location of the main body opposite to the location being held for writing, so complying with the ergonomic requirement is not achieved, and problems such as inadequate effort for holding, unstable operating, uncomfortable in use or even damage may occur; when in use, if writing on paper and sliding and pressing the touch panel for displaying data are both required to be operated, the main body has to be repeatedly turned, thereby wasting time and effort in use and causing inconvenience, the operation efficiency and practicability are severely affected.

For achieving the mentioned objectives, the present invention provides a touch pen structure, especially to a touch pen structure which can be used for replacing fingers to operate a touch screen, which includes:

a main body, formed as a shell body in which an accommodation space is formed, the main body includes an upper portion and a lower portion connected with each other, the bottom of the lower portion is installed with a pen head having a fasten part, the pen head is further formed with a stepped-like sleeve head part having an upper segment and a lower segment at the bottom of the fasten part, a recessed slot is formed between the upper segment and the lower segment of the sleeve head part;

at least one ascent/descent pen core, disposed in the accommodation space of the main body, and optionally installed with a spring capable of interacting with the lower portion;

an electric conductive touch sleeve, disposed at the lower segment of the sleeve head part of the lower portion of the main body, the center of the electric conductive touch sleeve is formed with a sleeve aperture allowing the ascent/descent pen core 13 to protrude, the top of the electric conductive touch sleeve is formed with a protruding flange, the protruding flange is corresponding to the recessed slot of the sleeve head part of the lower portion; and

an end cap, disposed at the bottom of the lower portion of the main body and used for fastening the electric conductive touch sleeve, the center of the end cap is formed with a conical hole allowing the bottom of the electric conductive touch sleeve to be outwardly protruded and the ascent/descent pen core to be ascended/descended, the inner top thereof is formed with an inner fasten part corresponding to the fasten part of the lower portion.

Preferably, according to the present invention, the main body is formed as a main body of retractable pen or formed as a main body of rotary pen or other main body structure.

Preferably, according to the present invention, the fasten part of the lower portion of the main body is formed as an outer thread, any other structure capable of providing similar fastening effect.

Furthermore, according to the present invention, the bottom of the lower segment of the sleeve head part is formed with a guiding angle.

Furthermore, according to the present invention, the top of the upper portion of the main body of retractable pen is installed with a press button, the bottom thereof is formed with an outer thread, the top of the lower portion connected therewith is formed with an inner thread corresponding to the outer thread.

Furthermore, according to the present invention, the bottom of the upper portion of the main body of rotary pen is installed with a rotary inner sleeve, the top of the lower portion connected therewith is formed with a sleeve hole corresponding to the rotary inner sleeve.

Preferably, according to the present invention, the material of which the electric conductive touch sleeve being made of is silicon or an electric conductive textile or other materials.

Preferably, according to the present invention, the sleeve aperture of the electric conductive touch sleeve is formed in a circular shape or cross shape or other shapes.

Preferably, according to the present invention, the inner fasten part of the end cap is formed as an inner thread or various structures capable of being fastened with the fasten part at the bottom of the lower portion.

With the disclosed structure, the touch pen structure is able to be directly used for sliding and pressing on the touch panel and also writing on the paper without turning the main body, thereby providing convenience in use and increasing the holding strength and stability; accordingly, the touch pen structure provided by the present invention is novel and practical in use comparing to prior art.

### BRIEF DESCRIPTION OF THE DRAWINGS

FIG. 1 is a perspective exploded view showing the touch pen structure according to one embodiment of the present invention;

FIG. 2 is a perspective view showing the assembly the touch pen structure according to one embodiment of the present invention;

FIG. 3 is a cross sectional view showing the assembly the touch pen structure according to one embodiment of the present invention;

FIG. 4 is a perspective exploded view showing the touch pen structure according to another embodiment of the present invention;

FIG. 5 is a perspective view showing the assembly the touch pen structure according to another embodiment of the present invention;

FIG. 6 is a cross sectional view showing the assembly the touch pen structure according to another embodiment of the present invention;

FIG. 7 is a schematic view illustrating the touch pen being used for sliding and pressing on a touch panel according to one embodiment of the present invention;

FIG. 8 is a schematic view illustrating the pen core shown in FIG. 3 being protruded from the electric conductive touch sleeve according to one embodiment of the present invention;

FIG. 9 is a schematic view illustrating the pen core shown in FIG. 6 being protruded from the electric conductive touch sleeve according to one embodiment of the present invention; and

FIG. 10 is a schematic view illustrating the touch pen being used for writing on paper according to one embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention. The accompanying drawings are only served for illustration; in actual practice, the relative ratio and precision arrangement of disclosed components and the scope of the present invention shall not be limited to the provided drawings.

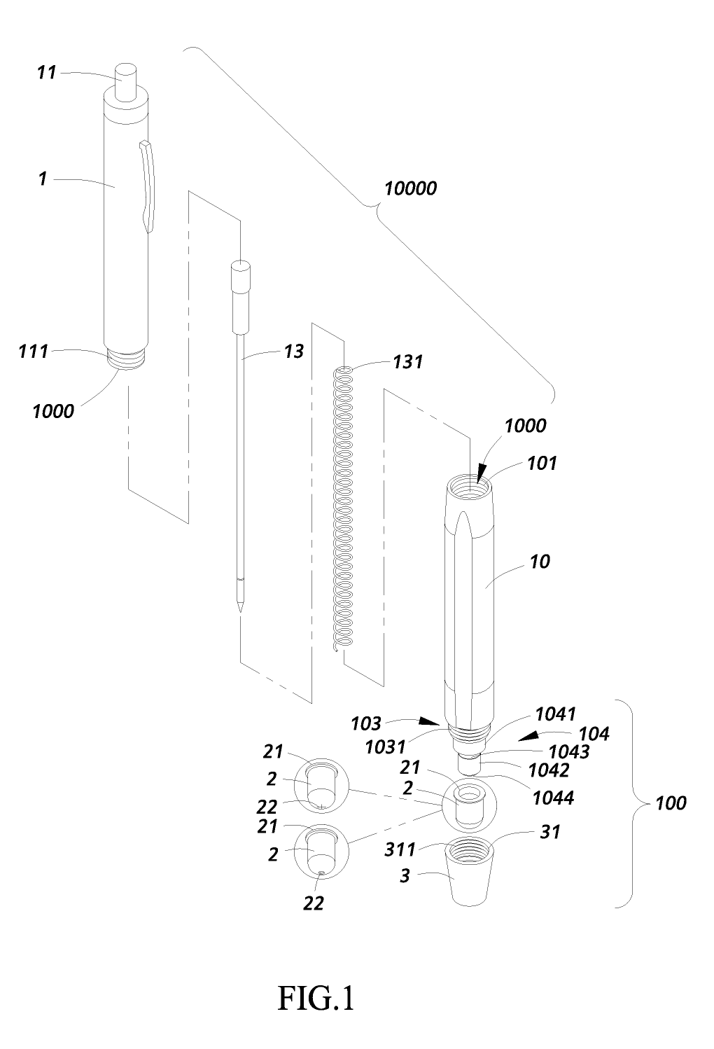

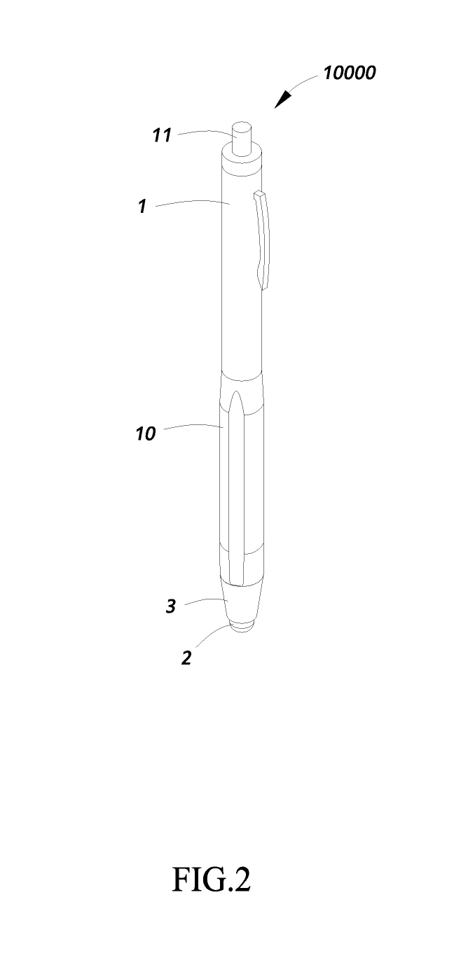

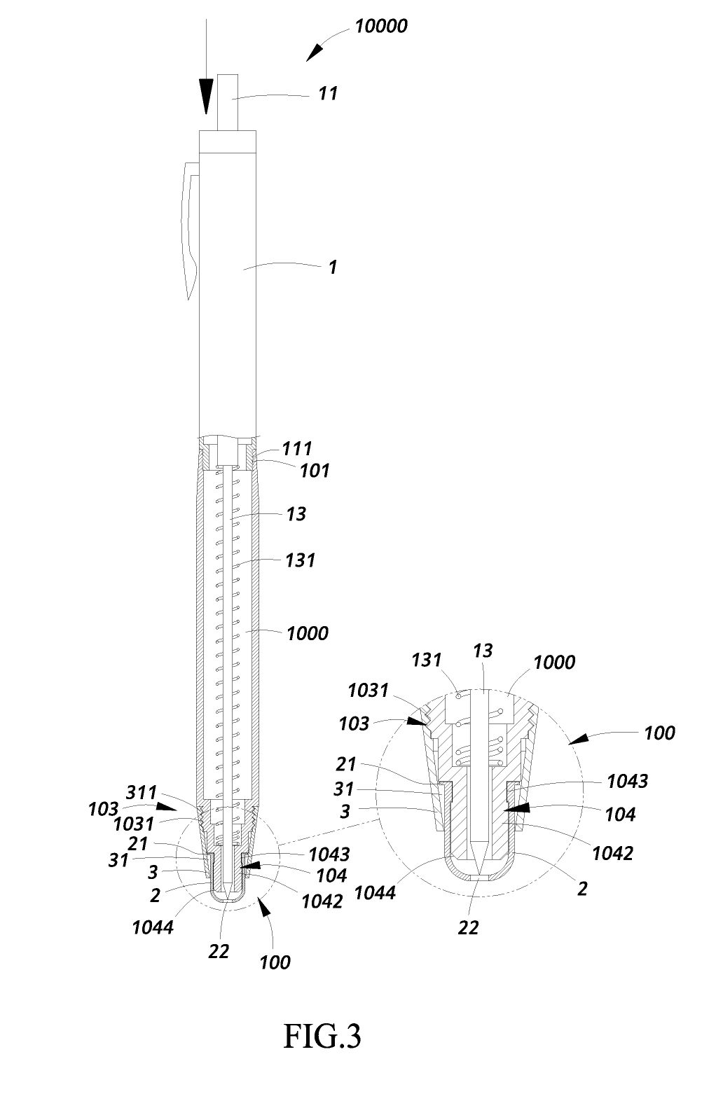

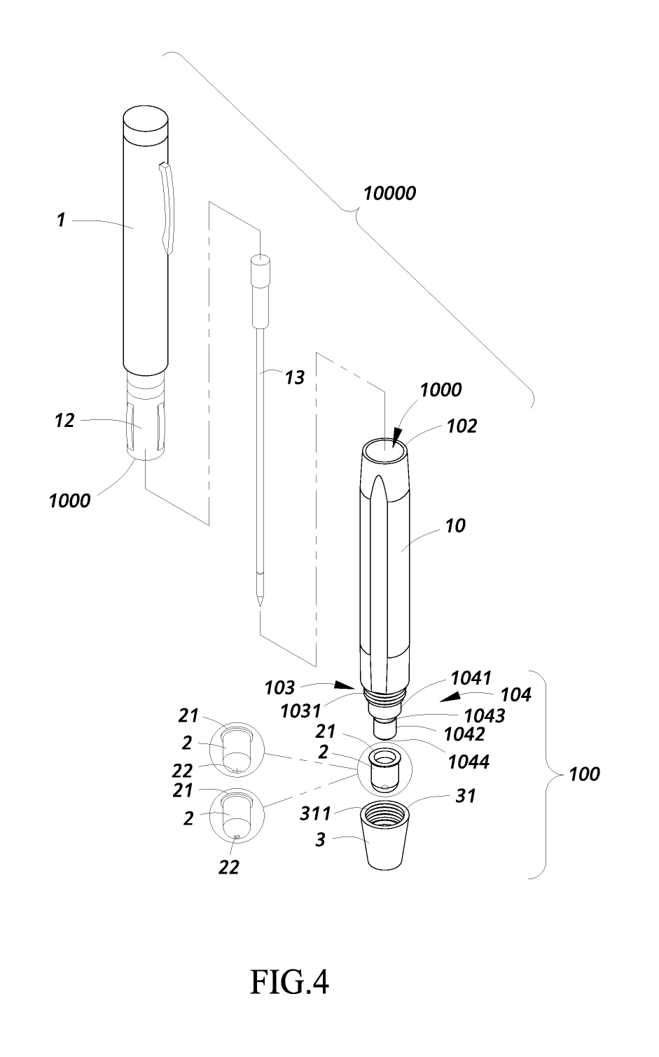

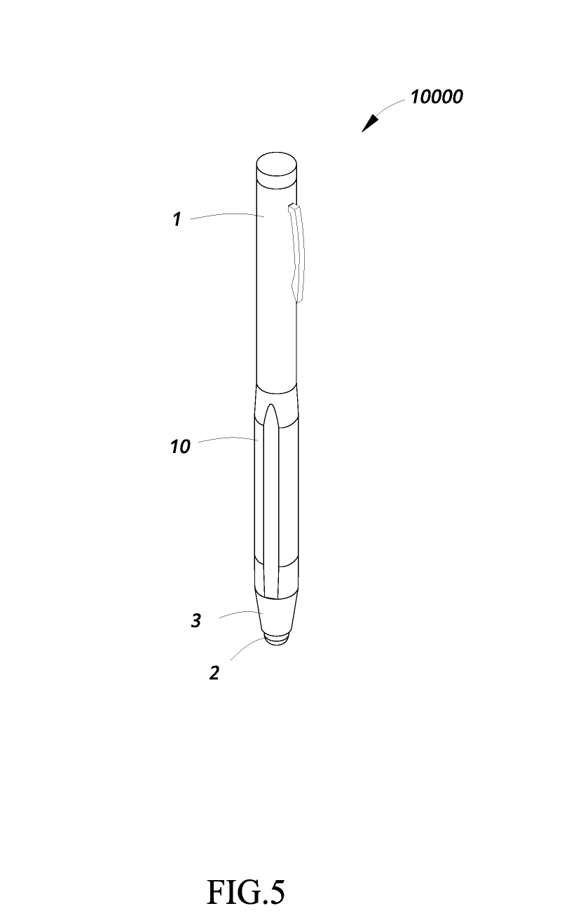

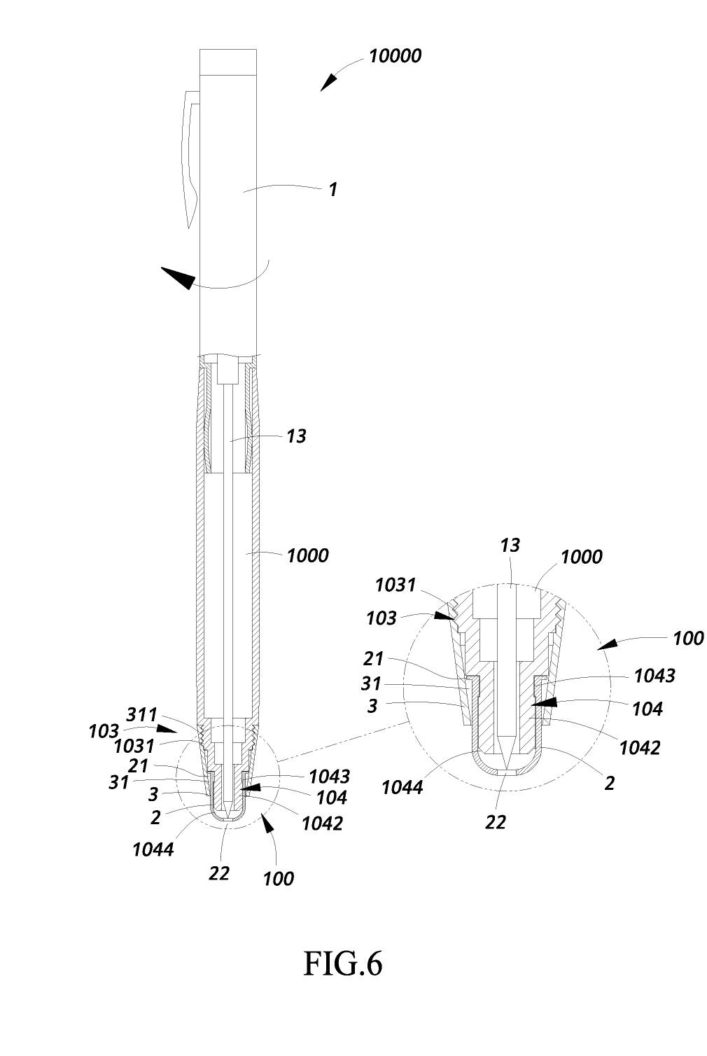

Referring from FIG. 1 to FIG. 6, wherein FIG. 1 is a perspective exploded view showing the touch pen structure according to one embodiment of the present invention; FIG. 2 is a perspective view showing the assembly the touch pen structure according to one embodiment of the present invention; FIG. 3 is a cross sectional view showing the assembly the touch pen structure according to one embodiment of the present invention; FIG. 4 is a perspective exploded view showing the touch pen structure according to another embodiment of the present invention; FIG. 5 is a perspective view showing the assembly the touch pen structure according to another embodiment of the present invention; and FIG. 6 is a cross sectional view showing the assembly the touch pen structure according to another embodiment of the present invention. The present invention provides a touch pen structure, especially to a touch pen structure which can be used for replacing fingers to operate a touch screen. According to one preferred embodiment of the present invention, the touch pen structure includes a main body 10000, at least a pen core 13, an electric conductive touch sleeve 2 and an end cap 3.

The main body 10000 is formed as a shell body in which an accommodation space 1000 is formed, the main body 10000 includes an upper portion 1 and a lower portion 10 connected with each other. The bottom of the lower portion 10 is installed with a pen head 100 having a fasten part 103, according to this embodiment, the fasten part 103 of the lower portion 10 of the main body 10000 is formed as an outer thread 1031, what shall be addressed is that the scope of the present invention is not limited to the disclosed arrangement, any other structure capable of providing similar fastening effect is within the scope of the present invention. The pen head 100 is further formed with a stepped-like sleeve head part 104 having an upper segment 1041 and a lower segment 1042 at the bottom of the fasten part 103, a recessed slot 1043 is formed between the upper segment 1041 and the lower segment 1042 of the sleeve head part 104, the bottom of the lower segment 1042 of the sleeve head part 104 is formed with a guiding angle 1044 used for guiding and providing convenient installation, according the this embodiment, the main body 10000 is formed as a main body of retractable pen (as shown in FIG. 1, FIG. 2 and FIG. 3) or formed as a main body of rotary pen (as shown in FIG. 4, FIG. 5 and FIG. 6) or other main body structure. The top of the upper portion 1 of the main body of retractable pen is installed with a press button 11, the bottom thereof is formed with an outer thread 111, the top of the lower portion 10 connected therewith is formed with an inner thread 101 corresponding to the outer thread 111 (as shown in FIG. 1, FIG. 2 and FIG. 3); the bottom of the upper portion 1 of the main body of rotary pen is installed with a rotary inner sleeve 12, the top of the lower portion 10 connected therewith is formed with a sleeve hole 102 corresponding to the rotary inner sleeve 12 (as shown in FIG. 4, FIG. 5 and FIG. 6).

The at least one ascent/descent pen core 13 is disposed in the accommodation space 1000 of the main body 10000, and optionally installed with a spring 131 capable of interacting with the lower portion 10.

The electric conductive touch sleeve 2 is disposed at the lower segment 1042 of the sleeve head part 104 of the lower portion 10 of the main body 10000, the center of the electric conductive touch sleeve 2 is formed with a sleeve aperture 22 allowing the ascent/descent pen core 13 to protrude, the top of the electric conductive touch sleeve 2 is formed with a protruding flange 21, the protruding flange 21 is corresponding to the recessed slot 1043 of the sleeve head part 104 of the lower portion 10; preferably, the material of which the electric conductive touch sleeve 2 being made of is silicon or an electric conductive textile or other materials, the materials having the disclosed electric conductive feature are all within the scope of the present invention, the sleeve aperture 22 of the electric conductive touch sleeve 2 is formed in a circular shape or cross shape or other shapes, the shapes allowing the pen core to protrude are all within the scope of the present invention.

The end cap 3 is disposed at the bottom of the lower portion 10 of the main body 10000 and used for fastening the electric conductive touch sleeve 2, the center of the end cap 3 is formed with a conical hole 31 allowing the bottom of the electric conductive touch sleeve 2 to be outwardly protruded and the pen core 13 to be ascended/descended, the inner top thereof is formed with an inner fasten part 311 corresponding to the fasten part 103 of the lower portion 10, preferably, the inner fasten part 311 is formed as an inner thread 3111, what shall be addressed is that the scope of the present invention is not limited to the disclosed arrangement, various structures capable of being fastened with the fasten part 103 at the bottom of the lower portion 10 are all within the scope of the present invention.

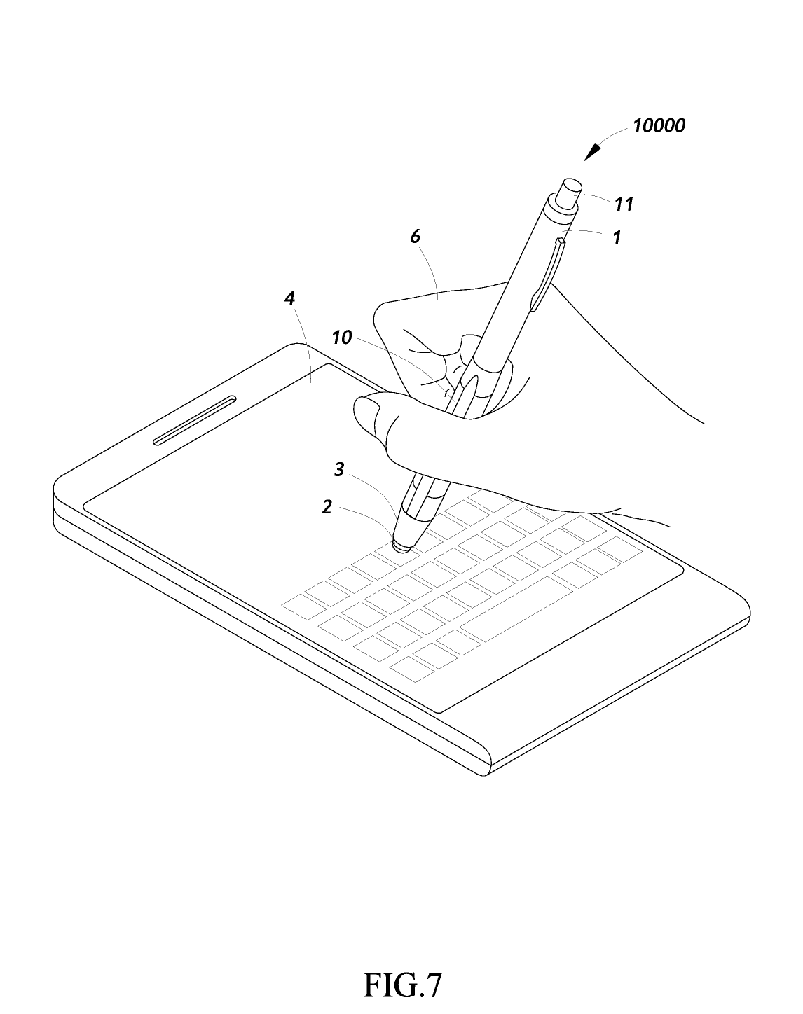

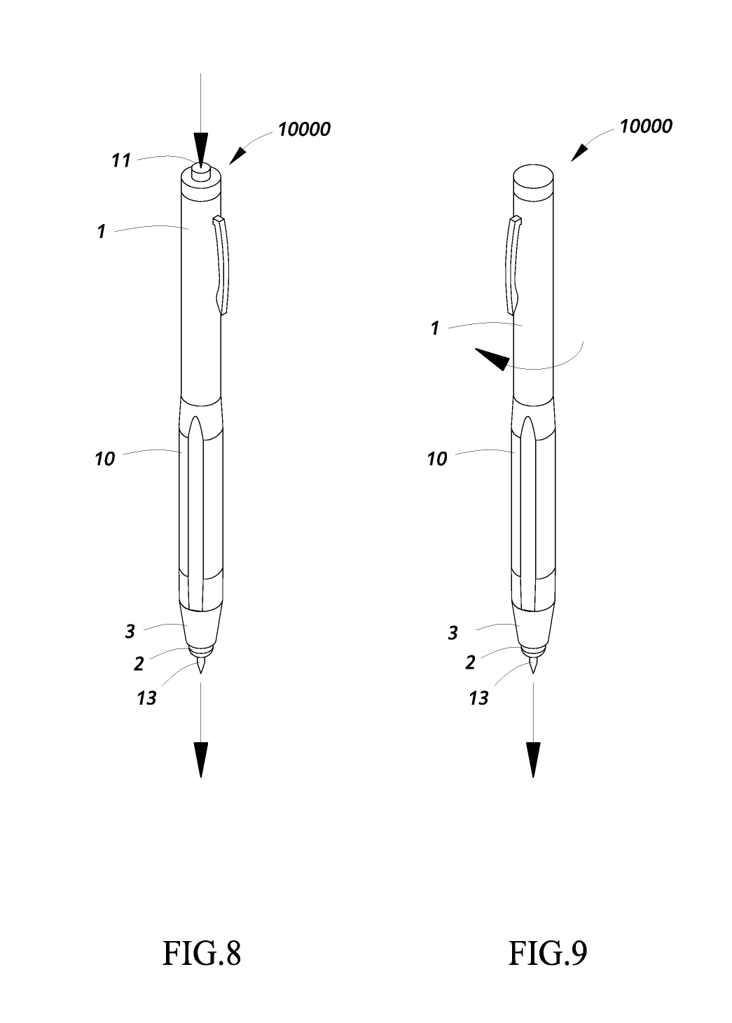

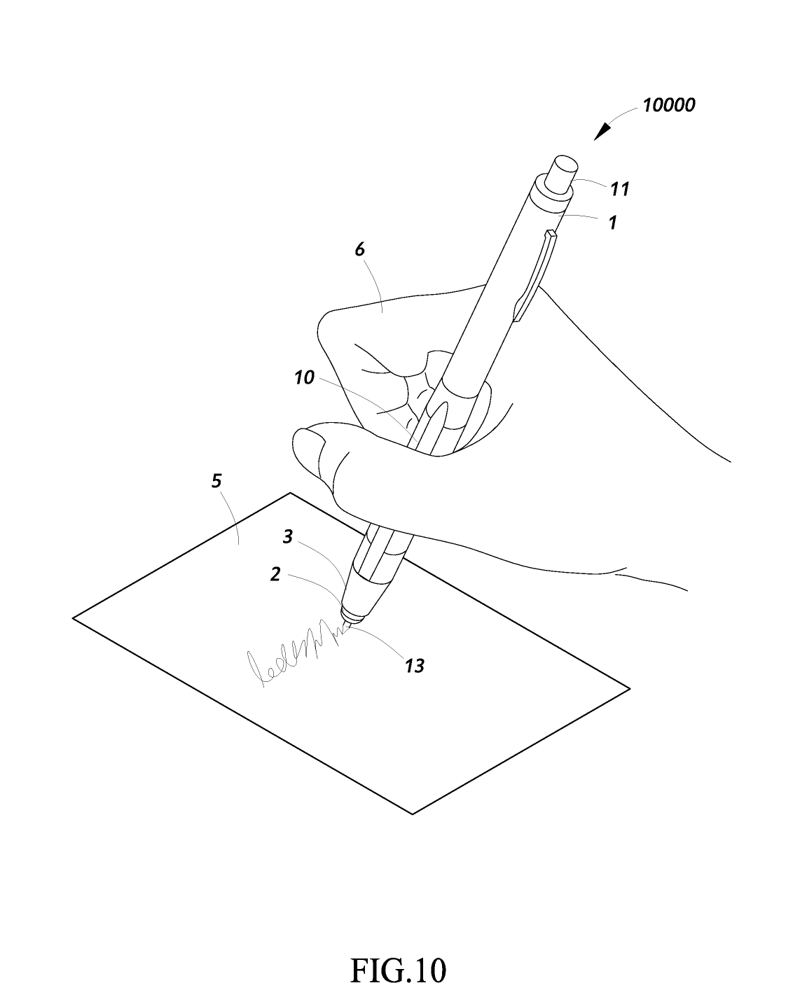

Referring from FIG. 7 to FIG. 10, wherein FIG. 7 is a schematic view illustrating the touch pen being used for sliding and pressing on a touch panel according to one embodiment of the present invention; FIG. 8 is a schematic view illustrating the pen core shown in FIG. 3 being protruded from the electric conductive touch sleeve according to one embodiment of the present invention; FIG. 9 is a schematic view illustrating the pen core shown in FIG. 6 being protruded from the electric conductive touch sleeve according to one embodiment of the present invention; and FIG. 10 is a schematic view illustrating the touch pen being used for writing on paper according to one embodiment of the present invention. According to the present invention, when the touch pen is desired to be used for sliding and pressing on a touch panel 4, the main body 10000 is held by a hand 6, the electric conductive touch sleeve 2 protruded from the end cap 3 is enabled to interact with the touch panel 4 (as shown in FIG. 7); when the touch pen is desired to be used for writing on a piece of paper 5, the press button 11 installed at the top of the upper portion 1 of the main body 10000 is pressed (as shown in FIG. 8) or the main body 10000 having the rotary inner sleeve 12 of the upper portion 1 being sleeved with the lower portion 10 is held by the hand 6 for directly rotating the upper portion 1 or the lower portion 10 (as shown in FIG. 9), at this moment, the ascent/descent pen core 13 disposed in the main body 10000 is able to be protruded from the sleeve aperture 22 formed at the center of the electric conductive touch sleeve 2 thereby being enabled to be used for writing (as shown in FIG. 10); when the service of touch pen is no longer desired, the press button 11 is pressed again or the upper portion 1 or the lower portion 10 is reversely rotated for allowing the ascent/descent pen core 13 to be retracted for recovering to the state disclosed from FIG. 1 to FIG. 3 and FIG. 4 to FIG. 6.

With the disclosed structure, the touch pen structure is able to be used for sliding and pressing on the touch panel 4 and also writing on the paper 5 without turning the main body 10000, thereby providing convenience in use and increasing the holding strength and stability. Accordingly, the touch pen structure provided by the present invention is novel and practical in use comparing to prior art.

As what has been disclosed above, the present invention is novel and the technical characteristic of this invention has not been published or used in public, so the technical characteristic disclosed in the present invention is not an art that is well known by skilled people. Moreover, the present invention can effectively solve the shortages existed in prior art and can satisfy the needs required by users and consumers, so it is known that the present invention cannot be invented without innovation and technical improvement. Thus, the present invention has complied with the element of novelty and non-obviousness for patentability.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation. Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.
1042 lower segment
1043 recessed slot
1044 guiding angle
13 ascent/descent pen core
131 spring
2 electric conductive touch sleeve
21 protruding flange
22 sleeve aperture
3 end cap
31 conical hole
311 inner fasten part
4 touch screen
5 paper
6 hand

What is claimed is:

1. A touch pen structure, especially used for replacing fingers to operate a touch screen, including:
a main body, formed as a shell body in which an accommodation space is formed, the main body includes an upper portion and a lower portion connected with each other, the bottom of the lower portion is installed with a pen head having a fasten part, the pen head is further formed with a stepped-like sleeve head part having an upper segment and a lower segment at the bottom of the fasten part, a recessed slot is formed between the upper segment and the lower segment of the sleeve head part, the bottom of the lower segment of the sleeve head part is formed with a guiding angle;
at least one ascent/descent pen core, disposed in the accommodation space of the main body, and optionally installed with a spring capable of interacting with the lower portion;
an electric conductive touch sleeve, disposed at the lower segment of the sleeve head part of the lower portion of the main body, the center of the electric conductive touch sleeve is formed with a sleeve aperture allowing the ascent/descent pen core to protrude, the top of the electric conductive touch sleeve is formed with a protruding flange, the protruding flange is corresponding to the recessed slot of the sleeve head part of the lower portion; and
an end cap, disposed at the bottom of the lower portion of the main body and used for fastening the electric conductive touch sleeve, the center of the end cap is formed with a conical hole allowing the bottom of the electric conductive touch sleeve to be outwardly protruded and the ascent/descent pen core to be ascended/descended, the inner top thereof is formed with an inner fasten part corresponding to the fasten part of the lower portion.

2. The touch pen structure according to claim 1, wherein the main body is formed as a main body of retractable pen or formed as a main body of rotary pen or other main body structure.

3. The touch pen structure according to claim 2, wherein the top of the upper portion of the main body of retractable pen is installed with a press button, the bottom thereof is formed with an outer thread, the top of the lower portion connected therewith is formed with an inner thread corresponding to the outer thread.

4. The touch pen structure according to claim 2, wherein the bottom of the upper portion of the main body of rotary pen is installed with a rotary inner sleeve, the top of the lower portion connected therewith is formed with a sleeve hole corresponding to the rotary inner sleeve.

5. The touch pen structure according to claim 1 wherein the fasten part of the lower portion of the main body is formed as an outer thread or any other structure capable of providing similar fastening effect.

6. The touch pen structure according to claim 3 wherein the fasten part of the lower portion of the main body is formed as an outer thread or any other structure capable of providing similar fastening effect.

7. The touch pen structure according to claim 4 wherein the fasten part of the lower portion of the main body is formed as an outer thread or any other structure capable of providing similar fastening effect.

8. The touch pen structure according to claim 1, wherein the sleeve aperture of the electric conductive touch sleeve is formed in a circular shape or cross shape or other shapes.

9. The touch pen structure according to claim 3, wherein the sleeve aperture of the electric conductive touch sleeve is formed in a circular shape or cross shape or other shapes.

10. The touch pen structure according to claim 4, wherein the sleeve aperture of the electric conductive touch sleeve is formed in a circular shape or cross shape or other shapes.

11. The touch pen structure according to claim 5, wherein the inner fasten part of the end cap is formed as an inner thread or various structures capable of being fastened with the fasten part at the bottom of the lower portion.

12. The touch pen structure according to claim 6, wherein the inner fasten part of the end cap is formed as an inner thread or various structures capable of being fastened with the fasten part at the bottom of the lower portion.

13. The touch pen structure according to claim 7, wherein the inner fasten part of the end cap is formed as an inner thread or various structures capable of being fastened with the fasten part at the bottom of the lower portion.
